(19) United States
(12) Patent Application Publication
(10) Pub. No.: US 2026/0180615 A1
(43) Pub. Date: Jun. 25, 2026

(54) HIGH LINEARITY HARMONIC REJECTION MIXERS

(71) Applicant: Analog Devices, Inc., Wilmington, MA (US)

(72) Inventors: Jianxun Zhu, Piscataway, NJ (US); Hyman Shanan, Piscataway, NJ (US)

(21) Appl. No.: 18/990,331

(22) Filed: Dec. 20, 2024

(51) Int. Cl. H04B 1/50; H04B 1/00

(52) U.S. Cl. CPC H04B 1/50; H04B 1/0067

(57) ABSTRACT

High linearity harmonic rejection mixers are disclosed herein. In certain embodiments, a mixer operates to mix a signal received at an input with a local oscillator signal from a local oscillator. The mixer includes a plurality of in-phase (I) signal paths and a plurality of quadrature-phase (Q) signals paths that are selectively activated by a plurality of clock signal phases of the local oscillator signal. For example, each clock signal phase selects a corresponding I signal path and Q signal path that are active for that clock signal phase. The mixer is implemented such that a total absolute current of the I signal path and the Q signal path is substantially constant for each of the clock signal phases.

### FIELD OF THE DISCLOSURE

Embodiments of the invention relate to electronic systems, and more particularly to, mixers used in radio frequency (RF) communication systems.

### BACKGROUND

Radio transceivers are used to transmit and receive RF signals associated with a wide variety of proprietary and non-proprietary communications standards. Example applications for radio transceivers include, but are not limited to, cellular electronics, radar systems, instrumentation, industrial electronics, military electronics, laptop computers, and/or digital radios.

One component of a radio transceiver is a mixer, which can be used to shift a signal in frequency. For example, a mixer can be used to upshift a transmit signal in frequency or to downshift a receive signal in frequency.

### SUMMARY OF THE DISCLOSURE

High linearity harmonic rejection mixers are disclosed herein. In certain embodiments, a mixer operates to mix a signal received at an input with a local oscillator signal from a local oscillator. The mixer includes a plurality of in-phase (I) signal paths and a plurality of quadrature-phase (Q) signals paths that are selectively activated by a plurality of clock signal phases of the local oscillator signal. For example, each clock signal phase selects a corresponding I signal path and Q signal path that are active for that clock signal phase. The mixer is implemented such that a total absolute current of the I signal path and the Q signal path is substantially constant for each of the clock signal phases. By implementing the mixer in this manner, a constant impedance is presented at the input of the mixer across clock signal phases. Thus, a combining ratio for the I signal paths and Q signal paths is independent of RF source impedance, which facilitates interfacing the mixer with other components, such as an attenuator or amplifier.

In one aspect, a mixer includes a plurality of in-phase (I) signal paths controlled by a plurality of clock signal phases of a local oscillator and a plurality of quadrature-phase (Q) signals paths controlled by the plurality of clock signal phases. Each clock signal phase of the plurality of clock signal phases selects a corresponding I signal path of the plurality of I signal paths and a corresponding Q signal path of the plurality of Q signal paths. Additionally, a total absolute current from the plurality of I signal paths and the plurality of Q signal paths is substantially constant for each of the clock signal phases.

In another aspect, a method of mixing with harmonic rejection is disclosed. The method includes controlling a plurality of in-phase (I) signal paths of a mixer using a plurality of clock signal phases of a local oscillator and controlling a plurality of quadrature-phase (Q) signals paths of the mixer using the plurality of clock signal phases. Each clock signal phase of the plurality of clock signal phases selects a corresponding I signal path of the plurality of I signal paths and a corresponding Q signal path of the plurality of Q signal paths. The method further includes maintaining a total absolute current from the plurality of I signal paths and the plurality of Q signal paths substantially constant for each of the clock signal phases.

In another aspect, a radio frequency communication system is disclosed. The radio frequency communication system includes a local oscillator configured to generate a plurality of clock signal phases, and a mixer. The mixer includes a plurality of in-phase (I) signal paths controlled by the plurality of clock signal phases and a plurality of quadrature-phase (Q) signals paths controlled by the plurality of clock signal phases. Each clock signal phase of the plurality of clock signal phases selects a corresponding I signal path of the plurality of I signal paths and a corresponding Q signal path of the plurality of Q signal paths. Additionally, wherein a total absolute current from the plurality of I signal paths and the plurality of Q signal paths is substantially constant for each of the clock signal phases.

### BRIEF DESCRIPTION OF THE DRAWINGS

FIG. 1 is a schematic diagram of one embodiment of a radio frequency (RF) communication system.

FIG. 2A is a schematic diagram of one embodiment of a receive mixer.

FIG. 2B is a graph of one example of clock signal phases for the receive mixer of FIG. 2A.

FIG. 3A is a schematic diagram of one example of an in-phase (I) and quadrature-phase (Q) sinusoidal weighting scheme for a mixer.

FIG. 3B is a graph of fluctuating input impedance for the I and Q sinusoidal weighting scheme of FIG. 3A.

FIG. 4A is a schematic diagram of another example of an I and Q sinusoidal weighting scheme for a mixer.

FIG. 4B is a graph of constant input impedance for the I and Q sinusoidal weighting scheme of FIG. 4A.

FIG. 5A is a schematic diagram of another embodiment of a receive mixer.

FIG. 5B is a schematic diagram of a portion of the receive mixer of FIG. 5A.

FIG. 5C is a schematic diagram of one embodiment of the portion of the receive mixer shown in FIG. 5B.

FIG. 5D is a graph of resistance and current characteristics versus phase for the receive mixer of FIG. 5A.

FIG. 6 is a schematic diagram of another embodiment of a receive mixer.

FIG. 7 is a schematic diagram of one embodiment of a receive mixer calibration system.

FIG. 8 is a schematic diagram of another embodiment of a receive mixer calibration system.

FIG. 9A is a schematic diagram of one embodiment of a transmit mixer.

FIG. 9B is a schematic diagram of a portion of the transmit mixer of FIG. 9A.

FIG. 9C is a schematic diagram of one embodiment of the portion of the transmit mixer shown in FIG. 9B.

FIG. 9D is a graph of transconductance and current characteristics versus phase for the transmit mixer of FIG. 9A.

FIG. 10 is a schematic diagram of one embodiment of a transmit mixer calibration system.

FIG. 11 is a schematic diagram of another embodiment of a transmit mixer calibration system.

### DETAILED DESCRIPTION

The following detailed description of embodiments presents various descriptions of specific embodiments of the invention. However, the invention can be embodied in a multitude of different ways. In this description, reference is made to the drawings where like reference numerals may indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

In certain applications it is desirable for a transceiver to be implemented with harmonic rejection mixers (HRMs) to provide enhanced rejection to signal harmonics. In one example, a software defined radio (SDR) is operable to support multiple frequency bands and radio access technologies (RATs), and it is desirable to have increased resilience to blockers over a wide frequency range, and particularly at harmonics of a local oscillator (LO).

Existing HRMs provide undesirable tradeoffs with respect to performance and/or cost. In one example, a HRM is implemented as a voltage-mode mixer, but suffers from low linearity. In another example, a HRM is implemented as a current-mode mixer, but suffers from high hardware overhead in terms of the number of transimpedance amplifiers (TIAs) and/or transconductance (Gm) cells. Further, such HRMs can suffer from reduced performance due to harmonic blockers not being rejected until after active combining, at which point the blockers may have already desensitized other circuits in the signal chain.

High linearity harmonic rejection mixers are disclosed herein. In certain embodiments, a mixer operates to mix a signal received at an input with a local oscillator signal from a local oscillator. The mixer includes a plurality of in-phase (I) signal paths and a plurality of quadrature-phase (Q) signals paths that are selectively activated by a plurality of clock signal phases of the local oscillator signal. For example, each clock signal phase selects a corresponding I signal path and Q signal path that are active for that clock signal phase. The mixer is implemented such that a total absolute current of the I signal path and the Q signal path is substantially constant for each of the clock signal phases.

By implementing the mixer in this manner, a constant impedance is presented at the input of the mixer across clock signal phases. Thus, a combining ratio for the I signal paths and Q signal paths is independent of RF source impedance, which facilitates interfacing the mixer with other components, such as an attenuator or amplifier.

The mixers herein can be implemented as receive mixers that downshift the frequency of a receive signal or as transmit mixers that upshift the frequency of a transmit signal. In some implementations, the mixers are passive and use passive components such as resistors to generate the currents of the I signal paths and Q signal paths. In other implementations, the mixers are active and use Gm cells or other active circuitry to generate the currents.

In certain implementations, the mixer provides harmonic rejection before active amplification, thus minimizing desensitization to other circuits in the signal chain.

The mixers herein can also share components across I signal paths or Q signal paths to provide a compact design and/or to reduce the total number of components. In one example, a receive mixer shares an I-channel TIA across each of the I signal paths and a Q-channel TIA across each of the Q signal paths. Thus, certain receive mixers herein can be implemented using only two TIAs (one for an I-channel and one for a Q-channel).

In certain implementations, the currents from the I signal paths and the Q signal paths are weighted according to sinusoidal functions to achieve weights needed for harmonic rejection. Furthermore, the weighted sinusoidal functions can be phase-shifted. In one example, a mixer includes n paths for each of the I signal paths and the Q signal paths, and the I signal paths are weighted according to a cosine function with a phase offset of about π/n, and the Q signal paths are weighted according to a sine function with a phase offset of about π/n. In one example, when n=8, the I signal paths are weighted according to W_{I}(k)=cos(π/4×k+π/8) and the Q signal paths are weighted according to W_{Q}(k)=sin (π/4×k+1/8) for k=0, 1, 2, . . . 7.

Calibrations schemes are also disclosed herein for calibrating the mixers to improve harmonic rejection. Such calibration schemes can also be used to account for other signal non-idealities, such as quadrature error.

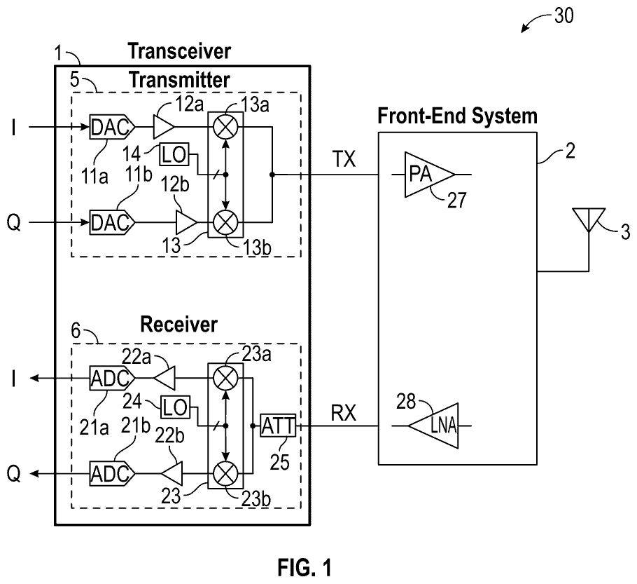

FIG. 1 is a schematic diagram of one embodiment of an RF communication system 30. The RF communication system 30 includes a transceiver 1, a front-end system 2, and an antenna 3. The transceiver 1 of FIG. 1 can include one or more mixers implemented in accordance with the teachings herein. However, the mixers disclosed herein can be used in other implementations of electronic systems.

In the illustrated embodiment, the transceiver 1 includes a transmitter 5 and a receiver 6. Although not depicted in FIG. 1, the transceiver 1 can also include other circuitry. Furthermore, although FIG. 1 depicts the transceiver 1 as including one transmitter and one receiver, the transceiver can include additional transmitter(s), receiver(s), and/or observation receiver(s).

In the illustrated embodiment, the transmitter 5 includes an I-channel DAC 11a, an I-channel amplifier 12a, a transmit mixer 13 (including an I-channel 13a and a Q-channel 13b), a Q-channel DAC 11b, a Q-channel amplifier 12b, and a transmit local oscillator (LO) 14. Although one example of transmitter circuitry is depicted, a transmitter can be implemented in other ways.

As skilled artisans will appreciate, an I-channel processes an in-phase signal, while a Q-channel processes a quadrature-phase signal that is separated in phase from the in-phase signal by about 90° or π/2 radians. Thus, an I signal and a Q signal have a quadrature phase relationship.

With continuing reference to FIG. 1, the I-channel DAC 11a converts a digital I signal to an analog I signal, which is amplified by the I-channel amplifier 12a. Additionally, the Q-channel DAC 11b converts a digital Q signal to an analog Q signal, which is amplified by the Q-channel amplifier 12b. The transmit LO 14 provides a multiphase local oscillator signal to the transmit mixer 13, which upconverts and combines the amplified analog I signal and the amplified analog Q signal to generate an RF transmit signal TX. The transmit mixer 13 can be implemented in accordance with any of the embodiments herein.

With continuing reference to FIG. 1, the receiver 6 includes an I-channel ADC 21a, an I-channel amplifier 22a, a receive mixer 23 (including an I-channel 23a and a Q-channel 23b), a Q-channel ADC 21b, a Q-channel amplifier 22b, a receive LO 24, and a gain-controllable attenuator (ATT) 25. Although one example of receiver circuitry is depicted, a receiver can be implemented in other ways.

With respect to signal reception, the receiver 6 receives an RF receive signal RX from the front-end system 2, which is attenuated by the gain-controlled attenuator 25 to generate an attenuated RF receive signal. The receive LO 24 provides a multiphase local oscillator signal to the receive mixer 23, which downconverts the attenuated RF receive signal to generate an analog I signal and an analog Q signal. The analog I signal is amplified by the I-channel amplifier 22a and digitized by the I-channel ADC 21a to generate a digital I signal. The analog Q signal is amplified by the Q-channel amplifier 22b and digitized by the Q-channel ADC 21b to generate a digital Q signal.

The transceiver 1 can be implemented in accordance with any of the embodiments herein. For example, the transmit mixer 13 and/or the receive mixer 23 can be implemented in accordance with one or more features of the present disclosure. Further, the transceiver 1 can be implemented in accordance with any of the calibration schemes disclosed herein.

As shown in FIG. 1, the front-end system 2 includes a power amplifier (PA) 27 that amplifies the RF transmit signal TX for transmission on the antenna 3, and a low noise amplifier (LNA) 28 that generates the RF receive signal RX based on amplifying a received signal from the antenna 3. Although only the power amplifier 27 and the low noise amplifier 28 are depicted in FIG. 1, the front-end system 2 can include other components including, but not limited to, filters, switches, duplexers, diplexers, and/or couplers. Moreover, transmitter 5 and the receiver 6 need not share an antenna, but rather can use separate antennas.

The transceiver 1 can handle signals of a variety of frequencies, including not only RF signals between 30 MHz and 7 GHz, but also signals of higher frequencies, such as those in the X band (about 7 GHz to 12 GHz), the Kᵤ band (about 12 GHz to 18 GHz), the K band (about 18 GHz to 27 GHz), the Kₐ band (about 27 GHz to 40 GHZ), the V band (about 40 GHz to 75 GHZ), and/or the W band (about 75 GHz to 110 GHz). Accordingly, the teachings herein are applicable to a wide variety of RF communication systems, including microwave systems.

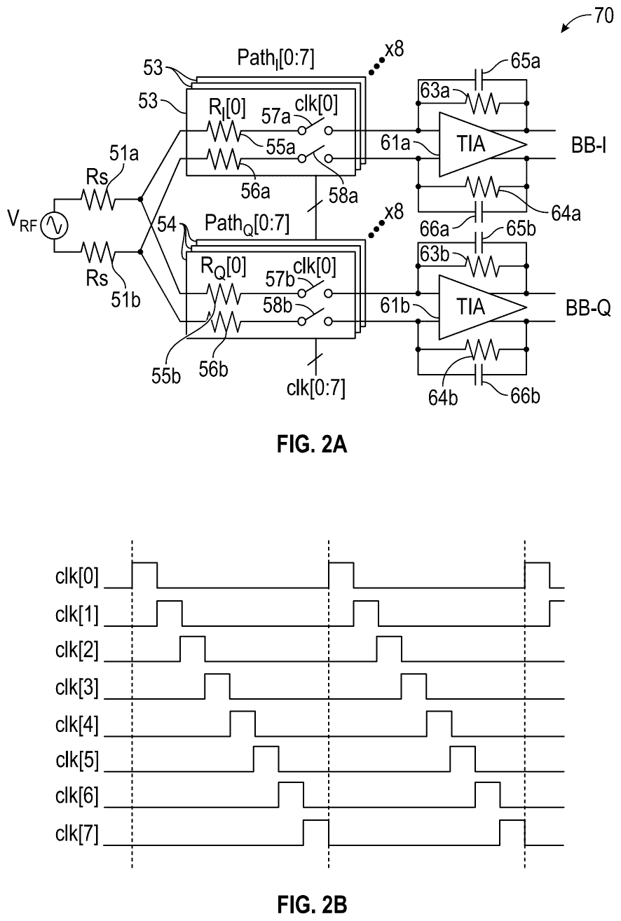

FIG. 2A is a schematic diagram of one embodiment of a receive mixer 70. FIG. 2B is a graph of one example of clock signal phases for the receive mixer 70 of FIG. 2A.

In the illustrated embodiment, the receive mixer 70 includes I-channel circuit branches or paths 53, Q-channel circuit branches or paths 54, an I-channel TIA 61a, a first I-channel feedback resistor 63a, a second I-channel feedback resistor 64a, a first I-channel feedback capacitor 65a, a second I-channel feedback capacitor 66a, a Q-channel TIA 61b, a first Q-channel feedback resistor 63b, a second Q-channel feedback resistor 64b, a first Q-channel feedback capacitor 65b, and a second Q-channel feedback capacitor 66b.

As shown in FIG. 2A, the receive mixer 70 includes an input that receives an RF signal from an RF signal source V_{RF}. The RF signal source V_{RF} is coupled to the I-channel paths 53 and to the Q-channel paths 54 through a first RF source impedance 51a and a second RF source impedance 51b. The first RF source impedance 51a and the second RF source impedance 51b each have a resistance Rs representing the impedance of the RF signal source V_{RF}.

The receive mixer 70 operates to mix the RF signal received at the input with an LO signal including multiple clock signal phases clk[0:7]. The receive mixer 70 outputs a baseband I-channel signal BB-I and a baseband Q-channel signal BB-Q. An example of the clock signal phases clk[0:7] are depicted in FIG. 2B. The example in FIG. 2B corresponds to an eight-phase LO with a 12.5% duty cycle clock. Although an example with 8 clock signal phases and 8 I and Q signal paths is shown, the teachings herein are applicable to mixers using other numbers of clock signal phases and signal paths.

In the illustrated embodiment, each of the I-channel paths 53 include a first resistor 55a, a first switch 57a in series with the first resistor 55a, a second resistor 56a, and a second switch 58a in series with the second resistor 56a. The first resistor 55a receives a non-inverted component of the RF signal from the RF signal source V_{RF}, while the second resistor 56a receives an inverted component of the RF signal from the RF signal source V_{RF}. The switches 57a/58a of a given circuit path are controlled by a corresponding one of the clock signal phases clk[0:7]. For example, the I-channel paths 53 (also referred to as Path[0:7]) include an I-channel path Path_{I}[0] controlled by clk[0], an I-channel path Path_{I}[1] controlled by clk[1], an I-channel path Path_{I}[2] controlled by clk[2], an I-channel path Path_{I}[3] controlled by clk[3], an I-channel path Path_{I}[4] controlled by clk[4], an I-channel path Path_{I}[5] controlled by clk[5], an I-channel path Path_{I}[6] controlled by clk[6], and an I-channel path Path_{I}[7] controlled by clk[7].

With continuing reference to FIGS. 2A and 2B, each of the Q-channel paths 54 includes a first resistor 55b, a first switch 57b in series with the first resistor 55b, a second resistor 56b, and a second switch 58b in series with the second resistor 56b. The first resistor 55b receives the non-inverted component of the RF signal from the RF signal source V_{RF}, while the second resistor 56b receives the inverted component of the RF signal from the RF signal source V_{RF}. The switches 57b/58b of a given circuit path are controlled by a corresponding one of the clock signal phases clk[0:7]. For example, the Q-channel paths 54 (also referred to as Path_{Q}[0:7]) include a Q-channel path Path_{Q}[0] controlled by clk[0], a Q-channel path Path_{Q}[1] controlled by clk[1], a Q-channel path Path_{Q}[2] controlled by clk[2], a Q-channel path Path_{Q}[3] controlled by clk[3], a Q-channel path Path_{Q}[4] controlled by clk[4], a Q-channel path Path_{Q}[5] controlled by clk[5], a Q-channel path Path_{Q}[6] controlled by clk[6], and a Q-channel path Path_{Q}[7] controlled by clk[7].

Accordingly, during each of the clock signal phases clk[0:7], one of the I-channel paths 53 is selected to be active for the I-channel and one of the Q-channel paths 54 is selected to be active for the Q-channel. Additionally, the weights of the resistors in each channel are weighted according to a sinusoidal function to provide harmonic rejection.

Although an example with eight circuit paths for each channel and corresponding clock signal phases is shown, the teachings herein are applicable to mixers including more or fewer circuit paths. In another example, a mixer includes four paths for each of the I-channel and the Q-channel. In yet another example, a mixer includes sixteen paths for each of the I-channel and the Q-channel.

With continuing reference to FIGS. 2A and 2B, the I-channel paths 53 share the I-channel TIA 61a, while the Q-channel paths 54 share the Q-channel TIA 61b. Each of the I-channel paths 53 is electrically connected between the RF signal source V_{RF} and the differential input to the I-channel TIA 61a. Additionally, the clock signal phases clk[0:7] operate to select one of the I-channel paths 53 to be active for the I-channel at a given time. The I-channel paths 53 collectively operate to generate an I-channel current that is amplified by the I-channel TIA 61a to generate the baseband I-channel signal BB-I. Each of the Q-channel paths 54 is electrically connected between the RF signal source V_{RF} and the differential input to the Q-channel TIA 61b. Additionally, the clock signal phases clk[0:7] operate to select one of the Q-channel paths 54 to be active for the I-channel at a given time. The Q-channel paths 54 collectively operate to generate a Q-channel current that is amplified by the Q-channel TIA 61b to generate the baseband Q-channel signal BB-Q.

In the illustrated embodiment, the first I-channel feedback resistor 63a and the first I-channel feedback capacitor 65a are electrically connected in parallel between a first input and a first output of the I-channel TIA 61a. Additionally, the second I-channel feedback resistor 64a and the second I-channel feedback capacitor 66a are electrically connected in parallel between a second input and a second output of the I-channel TIA 61a. The first Q-channel feedback resistor 63b and the first Q-channel feedback capacitor 65b are electrically connected in parallel between a first input and a first output of the Q-channel TIA 61b. Additionally, the second Q-channel feedback resistor 64b and the second Q-channel feedback capacitor 66b are electrically connected in parallel between a second input and a second output of the Q-channel TIA 61b. The first input and the second input of each TIA operate as a differential input, while the first output and the second output of each TIA operate as a differential output. Although one example of circuitry for providing feedback for the TIAs is shown, other implementations of feedback can be used.

The receive mixer 70 is implemented such that a total absolute current of the selected I signal path and the selected Q signal path is substantially constant for each of the clock signal phases. For example, the resistance values R_{I}[0:7] of the I-channel paths 53 and the resistance values R_{Q}[0:7] of the Q-channel paths 54 can be selected to provide an input impedance that remains constant even as the clock signal phases change the selected I signal path and selected Q signal path over time. The constant input impedance in turn leads to a constant input current for a given input signal level.

In certain embodiments herein, a total absolute current from the selected I signal path and the selected Q signal path varies by less than 25%, or more particularly less than 10%, across each of the clock signal phases. By implementing a mixer in this manner, a constant impedance is presented at the input of the mixer even as the clock signal phase changes from one phase to another.

With continuing reference to FIGS. 2A and 2B, the clock signal phases clk[0:7] operate to select one of the I-channel paths 53 to be active for the I-channel and one of the Q-channel paths 54 to be active for the Q-channel. Additionally, the weights of the resistors in each channel are weighted according to a sinusoidal function.

For example, the resistors of the I-channel path Path_{I}[0] have a resistance R_{I} [0], the resistors of the I-channel path Path_{I}[1] have a resistance R_{I} [1], the resistors of the I-channel path Path_{I}[2] have a resistance Rr [2], the resistors of the I-channel path Path_{I}[3] have a resistance R_{I} [3], the resistors of the I-channel path Path_{I}[4] have a resistance R_{I} [4], the resistors of the I-channel path Path_{I}[5] have a resistance R_{I} [5], the resistors of the I-channel path Path_{I}[6] have a resistance R_{I} [6], and the resistors of the I-channel path Path_{I}[7] have a resistance R_{I} [7]. Additionally, the resistors of the Q-channel path Path_{Q}[0] have a resistance R_{Q}[0], the resistors of the Q-channel path Path_{Q}[1] have a resistance R_{Q}[1], the resistors of the Q-channel path Path_{Q}[2] have a resistance R_{Q}[2], the resistors of the Q-channel path Path_{Q}[3] have a resistance R_{Q}[3], the resistors of the Q-channel path Path_{Q}[4] have a resistance R_{Q}[4], the resistors of the Q-channel path Path_{Q}[5] have a resistance R_{Q}[5], the resistors of the Q-channel path Path_{Q}[6] have a resistance R_{Q}[6], and the resistors of the Q-channel path Path_{Q}[7] have a resistance R_{Q}[7].

By selection of the resistance values for R_{I}[0:7] and R_{Q}[0:7] weighting for a sinusoidal function that provides harmonic cancellation is achieved.

In certain embodiments herein, a mixer is implemented with a sinusoidal weighting scheme in which the weights selected for R_{I}[0:7] and R_{Q}[0:7] are selected for a phase-shifted sine function in which phase starts at π/8, and increases in π/4 steps. By implementing the mixer in this manner, a more constant RF input current is achieved as the LO clock signal phase changes from one of the clock signal phases clk[0:7] to another.

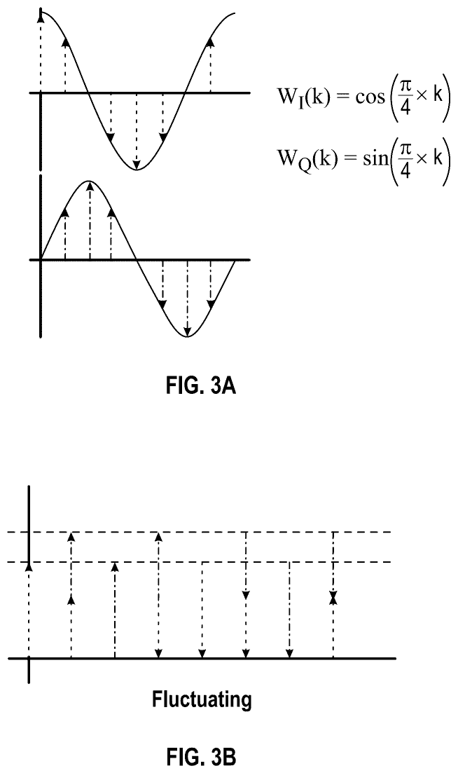

FIG. 3A is a schematic diagram of one example of an I and Q sinusoidal weighting scheme for a mixer. FIG. 3B is a graph of fluctuating input impedance for the I and Q sinusoidal weighting scheme of FIG. 3A.

With reference to FIGS. 3A and 3B, circuit elements of the I-channel paths (for example, (R_{I}[0:7] of the receive mixer 70 of FIG. 2A) are weighted according to W_{I}(k)=cos (π/4×k), while circuit elements of the Q-channel paths (for example, (R_{Q}[0:7] of the receive mixer 70 of FIG. 2A) are weighted according to W_{Q}(k)=sin (π/4×k).

As shown in FIG. 3B, weighting the circuit elements in this manner results in fluctuating input impedance as the LO clock signal phase changes from one phase to another. This fluctuating input impedance leads to an undesired change in RF input current over time.

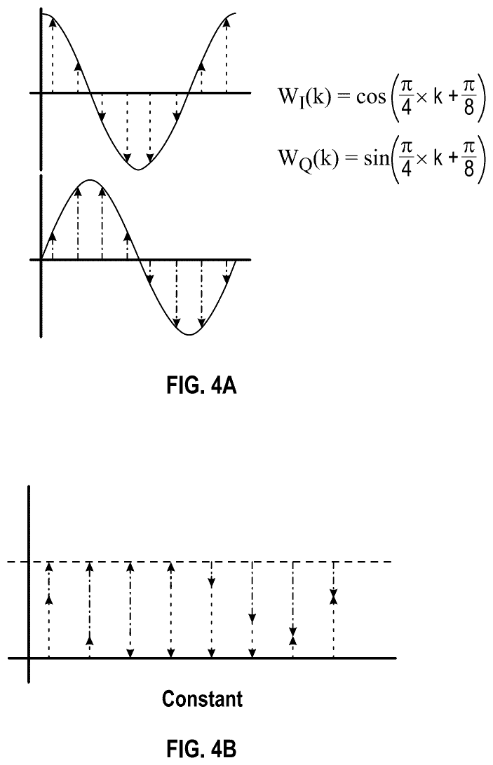

FIG. 4A is a schematic diagram of another example of an I and Q sinusoidal weighting scheme for a mixer. FIG. 4B is a graph of constant input impedance for the I and Q sinusoidal weighting scheme of FIG. 4A.

With reference to FIGS. 4A and 4B, circuit elements of the I-channel paths (for example, (R_{I}[0:7] of the mixer 70 of FIG. 2A) are weighted according to W_{I}(k)=cos (π/4×k+π/8), while circuit elements of the Q-channel paths (for example, (R_{Q}[0:7] of the mixer 70 of FIG. 2A) are weighted according to W_{Q}(k)=sin (π/4×k+1/8) for k=0, 1, 2, . . . 7.

As shown in FIG. 4B, weighting the circuit elements in this manner results in substantially constant input impedance as the LO clock signal phase changes from one phase to another. Thus, including a π/8 phase shift for an 8-path mixer for each of I and Q (or more generally, a n/n phase shift for an n-path mixer) provides a performance improvement by relative to a configuration in which non-phase shifted sine and cosine functions are used for weighting the paths of the mixer.

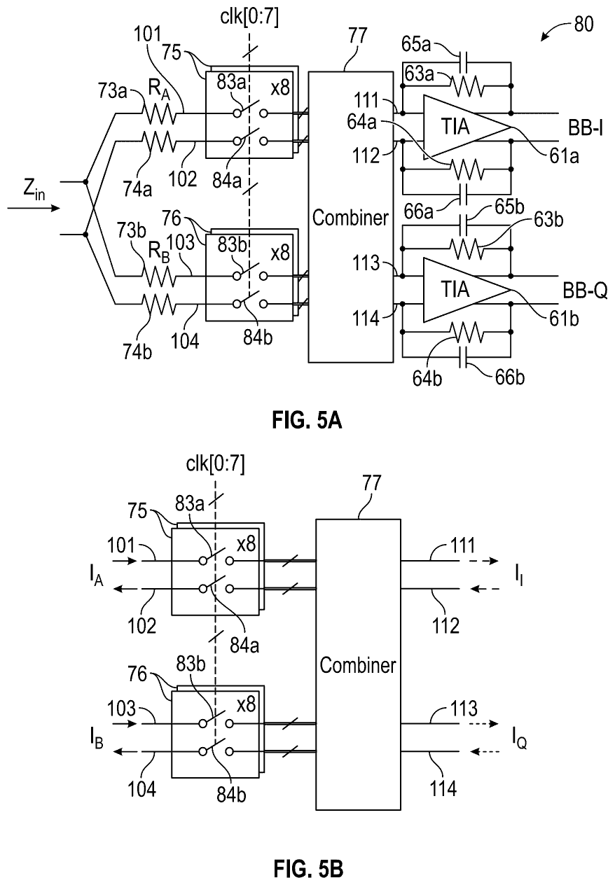

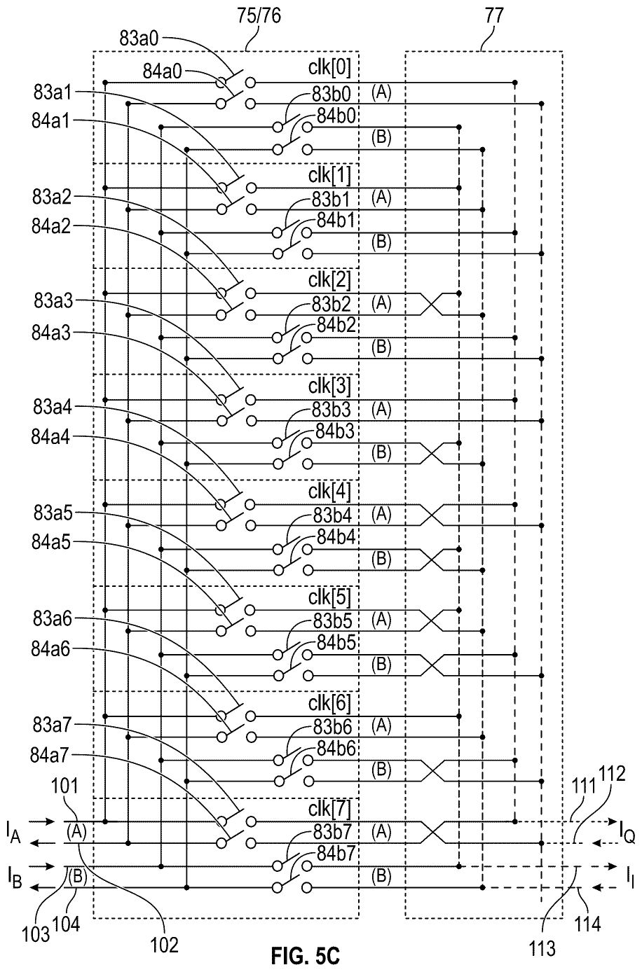

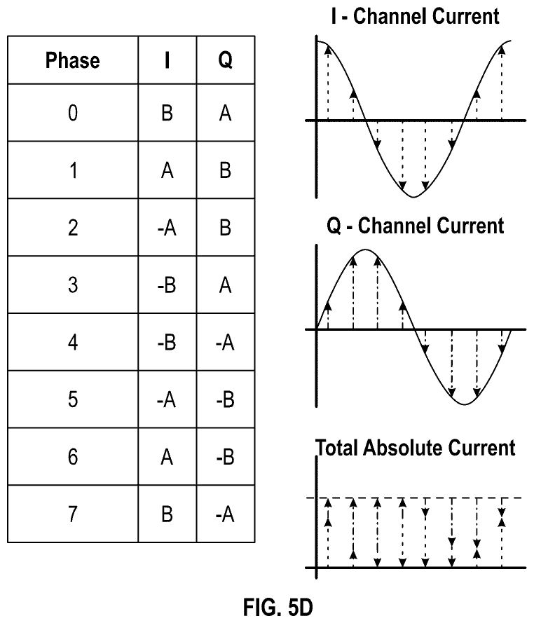

FIG. 5A is a schematic diagram of another embodiment of a receive mixer 80. FIG. 5B is a schematic diagram of a portion of the receive mixer 80 of FIG. 5A. FIG. 5C is a schematic diagram of one embodiment of the portion of the receive mixer shown in FIG. 5B. FIG. 5D is a graph of resistance and current characteristics versus phase for the receive mixer 80 of FIG. 5A.

With reference to FIGS. 5A-5D, the receive mixer 80 includes a first R_{A}-weighted resistor 73a, a second R_{A}-weighted resistor 74a, a first R_{B}-weighted resistor 73b, a second R_{B}-weighted resistor 74b, I-channel paths 75, Q-channel paths 76, an I-Q combiner 77, an I-channel TIA 61a, a first I-channel feedback resistor 63a, a second I-channel feedback resistor 64a, a first I-channel feedback capacitor 65a, a second I-channel feedback capacitor 66a, a Q-channel TIA 61b, a first Q-channel feedback resistor 63b, a second Q-channel feedback resistor 64b, a first Q-channel feedback capacitor 65b, and a second Q-channel feedback capacitor 66b.

In the illustrated embodiment, the I-channel paths 75 each include a first switch 83a electrically connected to the first R_{A}-weighted resistor 73a at a first input node 101 and a second switch 84a electrically connected to the second R_{A}-weighted resistor 74a at a second input node 102. A differential input current IA represents a difference in current between the first input node 101 and the second input node 102. Additionally, the Q-channel paths 76 each include a first switch 83b electrically connected to the first R_{B}-weighted resistor 73b at a third input node 103 and a second switch 84b electrically connected to the second R_{B}-weighted resistor 74b at a fourth input node 104. A differential input current I_{B} represents a difference in current between the third input node 103 and the fourth input node 104.

Each of the I-channel paths 75 is controlled by one of the clock signal phases clk[0:7]. Likewise, each of the Q-channel paths 76 is controlled by one of the clock signal phases clk[0:7]. For example, as shown in FIG. 5C, switches 83a0/84a0/83b0/84b0 are controlled by clk[0], switches 83a1/84a1/83b1/84b1 are controlled by clk[1], switches 83a2/84a2/83b2/84b2 are controlled by clk[2], switches 83a3/84a3/83b3/84b3 are controlled by clk[3], switches 83a4/84a4/83b4/84b4 are controlled by clk[4], switches 83a5/84a5/83b5/84b5 are controlled by clk[5], switches 83a6/84a6/83b6/84b6 are controlled by clk[6], and switches 83a7/84a7/83b7/84b7 are controlled by clk[7].

The switches of the I-channel paths 75 and the switches of the Q-channel paths 76 operate in combination with the I-Q combiner 77 to generate an I-channel current II between a first output node 111 and a second output node 112, and to generate a Q-channel current I_{Q} between a third output node 113 and a fourth output node 114.

The first R_{A}-weighted resistor 73a and the second R_{A}-weighted resistor 74a each have a resistance R_{A}, while the first R_{B}-weighted resistor 73b and the second R_{B}-weighted resistor 74b each have a resistance R_{B}. Thus, the I channel and the Q channel can each operate in one of four states (A, B, -A, -B) associated with whether a resistance R_{A} or a resistance R_{B} is connected to the channel and whether the I-Q combiner provides a signal inversion. The state A corresponds to selection of resistance R_{A} with no signal inversion, the state B corresponds to selection of resistance R_{B} with no signal inversion, the state-A corresponds to selection of resistance R_{A} with a signal inversion, and the state B corresponds to selection of resistance R_{B} with a signal inversion.

As shown in FIG. 5D, the selected states for the I channel correspond to those of W_{I}(k)=cos (π/4×k+π/8). For example, B is chosen for k=0 and k=7, A is chosen for k=1 and k=6, −A is chosen for k=2 and k=5, and −B is chosen for k=3 and k=4. Additionally, the selected states for the Q channel correspond to those of W_{I}(k)=sin (π/4×k+π/8). For example, A is chosen for k=0 and k=3, B is chosen for k=1 and k=2, −A is chosen for k=4 and k=7, and −B is chosen for k=5 and k=6.

By weighting the channels in this manner, the total absolute current is maintained constant as the clock signal phase changes from one clock signal phase to another.

The receive mixer 80 advantageously time shares resistors across the I-channel paths 75 and the Q-channel paths 76. For example, in the illustrated embodiment, a first pair of resistors with resistance R_{A} and a second pair of resistors with resistance R_{B} are rotated between I and Q channels to achieve substantially constant total absolute current while using a small number of components.

The resistance values of R_{A} and R_{B} can be selected to be any suitable values. In one example, R_{A}/R_{B} is selected to be about (√2+1)/1, for example, 2.414+/−10%. In certain implementations, the resistance values of R_{A} and R_{B} can be calibrated to achieve improved matching. Examples of calibration schemes are described further below.

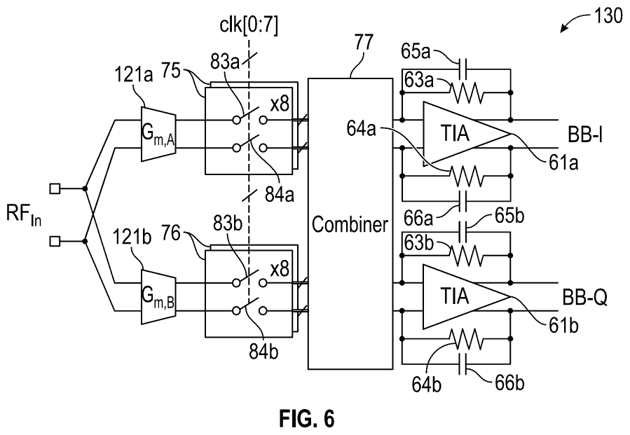

FIG. 6 is a schematic diagram of another embodiment of a receive mixer 130.

The receive mixer 130 of FIG. 6 is similar to the receive mixer 80 of FIG. 5A, except that the receive mixer 130 of FIG. 6 includes a first weighted transconductance cell 121a (with transconductance value G_{m,A}) instead of the R_{A}-weighted resistors 73a/74a and includes a second weighted transconductance cell 121b (with transconductance value G_{m,B}) instead of the R_{B}-weighted resistors 73b/74b.

Thus, the receive mixer 130 depicts an example of an active mixer that uses weighted transconductance cells (for example, field-effect transistors or bipolar transistors) rather than weighted resistors. The first weighted transconductance cell 121a and the second weighted transconductance cell 121b are time shared across the I-channel paths 75 and the Q-channel paths 76. The teachings herein are applicable to a wide variety of types of mixers, including both passive mixers and active mixers. Any of the mixers herein can replace weighted resistors with weighted transconductance cells or other suitable weighted components.

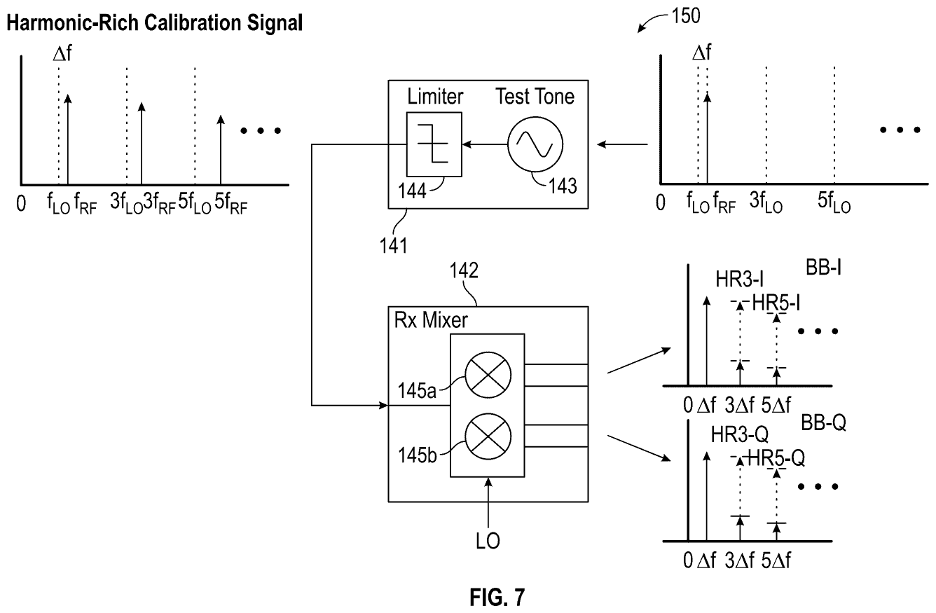

FIG. 7 is a schematic diagram of one embodiment of a receive mixer calibration system 150. The receive mixer calibration system 150 includes a calibration signal generator 141 and a receive mixer 142 that includes an I-channel 145a and a Q-channel 145b.

As shown in FIG. 7, the calibration signal generator 141 includes a test tone generator 143 and a limiter 144. The test tone generator 143 generates a test tone at a frequency f_{RF} that has a frequency offset Δf relative to the frequency f_{LO} of the LO clock signal used to generate the clock signal phases for the receive mixer 142. The test tone from the test tone generator 143 is provided to the limiter 144 to generate a harmonic-rich calibration signal that includes strong harmonic content at odd harmonics of f_{RF}.

By using the received fundamental tone as a reference, a rejection of each harmonic for both the I and Q channels can be calculated. The receive mixer calibration system 150 allows for simultaneous visibility of multiple harmonic rejection ratios. The output of the I-channel 145a and the output of the Q-channel 145b can be digitized (for example, using ADCs 21a/21b of FIG. 1) and processed by digital processing to detect the harmonic content (for instance, at harmonics of Δf). In such implementations, the receiver baseband should have sufficient linearity to distinguish between the harmonic folding products of the receive mixer 142 and the harmonic distortion products of baseband circuits.

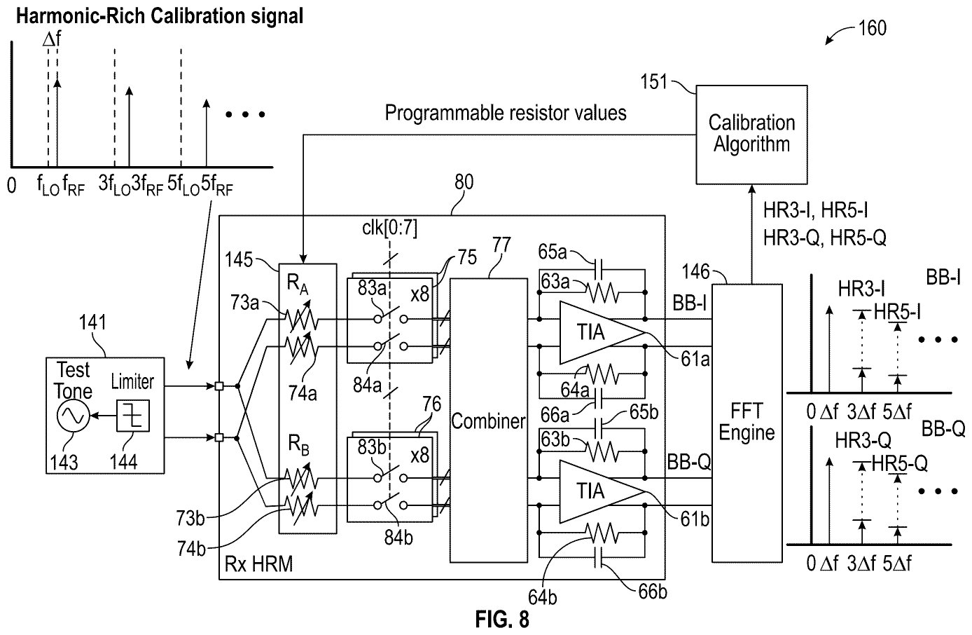

FIG. 8 is a schematic diagram of another embodiment of a receive mixer calibration system 160. The receive mixer calibration system 160 includes a calibration signal generator 141, a receive mixer 80, and digital processing circuitry implementing a fast-Fourier transform (FFT) engine 146 and a calibration algorithm 151.

The receive mixer calibration system 160 of FIG. 8 is similar to the receive mixer calibration system 150 of FIG. 7, except that in FIG. 8 a specific implementation of a receive mixer (corresponding to the receive mixer 80 of FIG. 5A) is undergoing calibration of resistance values R_{A} and R_{B} using an FFT analysis. In particular, the FFT engine 146 calculates the third-order harmonic components for the I-channel (HR3-I) and Q-channel (HR3-Q) as well as fifth-order harmonic components for the I-channel (HR5-I) and Q-channel (HR5-Q) in response to a harmonic rich test tone from the calibration signal generator 141.

In the illustrated embodiment, the calculated harmonics are provided to the calibration algorithm 151, which adjusts the values of the resistance values R_{A} and R_{B} to thereby calibrate the resistors 73a/74a/73b/74b to suitable resistance values for high harmonic rejection. For example, the calibration algorithm 151 can calibrate a ratio of R_{A}/R_{B} to a desired value, such as about (√2+1)/1.

In certain implementations, the calibration algorithm 151 performs additional calibrations, such as an adjustment of one or more components for quadrature error correction (QEC).

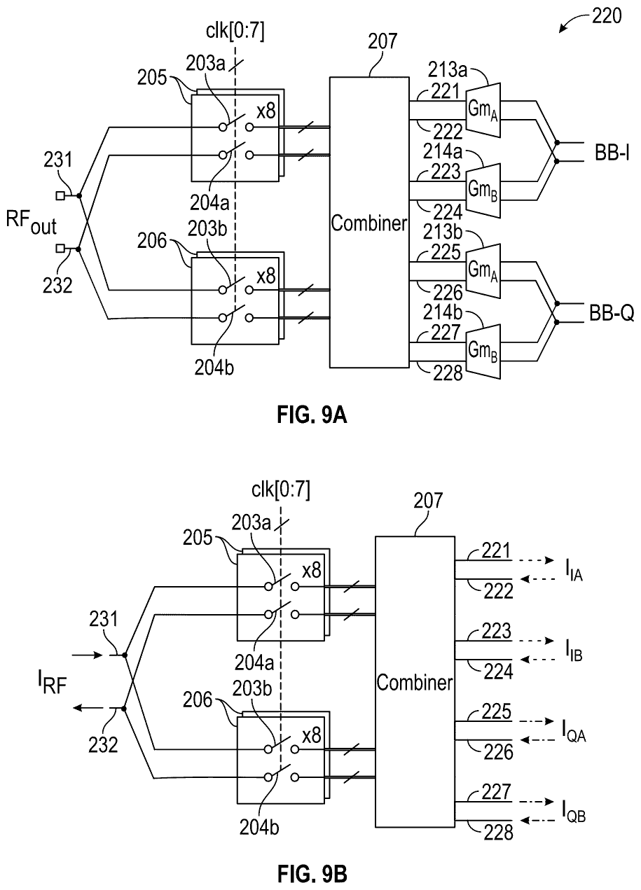

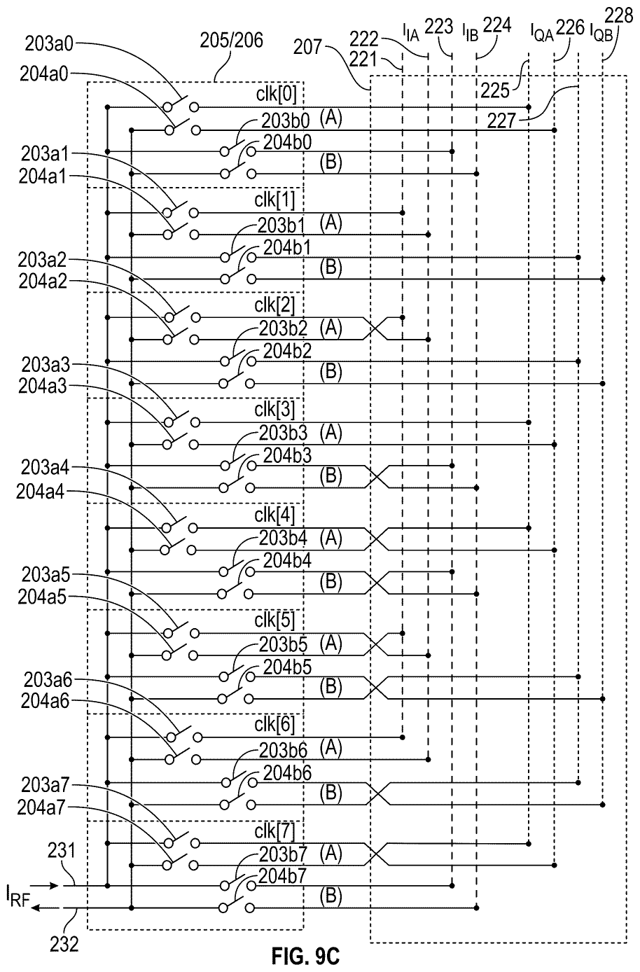

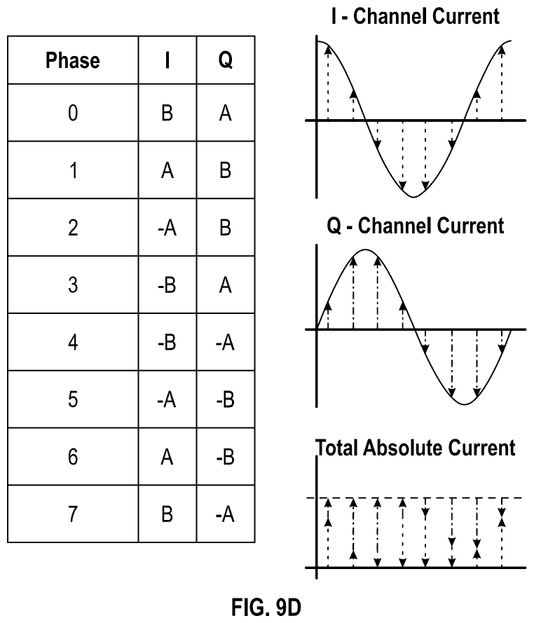

FIG. 9A is a schematic diagram of one embodiment of a transmit mixer 220. FIG. 9B is a schematic diagram of a portion of the transmit mixer 220 of FIG. 9A. FIG. 9C is a schematic diagram of one embodiment of the portion of the transmit mixer 220 shown in FIG. 9B. FIG. 9D is a graph of transconductance and current characteristics versus phase for the transmit mixer 220 of FIG. 9A.

With reference to FIGS. 9A-9D, the transmit mixer 220 includes a first Gm_{A}-weighted transconductor 213a, a second Gm_{A}-weighted transconductor 213b, a first Gm_{B}-weighted transconductor 214a, a second Gm_{B}-weighted transconductor 214b, an I-Q combiner 207, I-channel paths 205, and Q-channel paths 206.

In the illustrated embodiment, the first Gm_{A}-weighted transconductor 213a and the first Gm_{B}-weighted transconductor 214a each receive a baseband I-channel signal BB-I, while the second Gm_{A}-weighted transconductor 213b and the second Gm_{B}-weighted transconductor 214b each receive a baseband Q-channel signal BB-Q. The first Gm_{A}-weighted transconductor 213a and the second Gm_{A}-weighted transconductor 213b each have a transconductance Gm_{A}, while the first Gm_{B}-weighted transconductor 214a and the second Gm_{B}-weighted transconductor 214b each have a transconductance Gm_{B}.

The first Gm_{A}-weighted transconductor 213a provides a first differential I current I_{IA} between a first input node 221 and a second input node 222 to the I-Q combiner 207. Additionally, the first Gm_{B}-weighted transconductor 214a provides a second differential I current I_{B} between a third input node 223 and a fourth input node 224 to the I-Q combiner 207. Furthermore, the second Gm_{A}-weighted transconductor 213b provides a first differential Q current I_{QA} between a fifth input node 225 and a sixth input node 226 to the I-Q combiner 207. Additionally, the second Gm_{B}-weighted transconductor 214b provides a second differential Q current I_{QB} between a seventh input node 227 and an eighth input node 228 to the I-Q combiner 207.

In the illustrated embodiment, the I-channel paths 205 each include a first switch 203a electrically connected to a first output node 231 and a second switch 204a electrically connected to a second output node 232. A differential output current IRF represents a difference in current between the first output node 231 and the second output node 232. Additionally, the Q-channel paths 206 each include a first switch 203b electrically connected to the first output node 231 and a second switch 204b electrically connected to the second output node 232.

Each of the I-channel paths 205 is controlled by one of the clock signal phases clk[0:7]. Likewise, each of the Q-channel paths 206 is controlled by one of the clock signal phases clk[0:7]. For example, as shown in FIG. 9C, switches 203a0/204a0/203b0/204b0 are controlled by clk[0], switches 203a1/204a1/203b1/204b1 are controlled by clk[1], switches 203a2/204a2/203b2/204b2 are controlled by clk[2], switches 203a3/204a3/203b3/204b3 are controlled by clk[3], switches 203a4/204a4/203b4/204b4 are controlled by clk[4], switches 203a5/204a5/203b5/204b5 are controlled by clk[5], switches 203a6/204a6/203b6/204b5 are controlled by clk[6], and switches 203a7/204a7/203b7/204b7 are controlled by clk[7].

The switches of the I-channel paths 205 and the switches of the Q-channel paths 206 operate in combination with the I-Q combiner 207 to generate a differential output current IRF based on a weighted I-channel current and a weighted Q-channel current.

The first Gm_{A}-weighted transconductor 213a and the second Gm_{A}-weighted transconductor 213b each have a transconductance Gm_{A}, while the first Gm_{B}-weighted transconductor 214a and the second Gm_{B}-weighted transconductor 214b each have a transconductance Gm_{B}. Accordingly, the I channel and the Q channel can each operate in one of four states (A, B, -A, -B) associated with whether a transconductance Gm_{A} or a transconductance Gm_{B} is connected to the channel and whether the I-Q combiner 207 provides a signal inversion. The state A corresponds to selection of transconductance Gm_{A} with no signal inversion, the state B corresponds to selection of transconductance Gm_{B} with no signal inversion, the state-A corresponds to selection of transconductance Gm_{A} with a signal inversion, and the state B corresponds to selection of transconductance Gm_{B} with a signal inversion.

As shown in FIG. 9D, the selected states for the I channel correspond to those of W_{I}(k)=cos (π/4×k+1/8). For example, B is chosen for k=0 and k=7, A is chosen for k=1 and k=6, −A is chosen for k=2 and k=5, and −B is chosen for k=3 and k=4. Additionally, the selected states for the Q channel correspond to those of W_{I}(k)=sin (π/4×k+π/8). For example, A is chosen for k=0 and k=3, B is chosen for k=1 and k=2, −A is chosen for k=4 and k=7, and −B is chosen for k=5 and k=6.

By weighting the channels in this manner, the total absolute current is maintained constant as the clock signal phase changes from one clock signal phase to another.

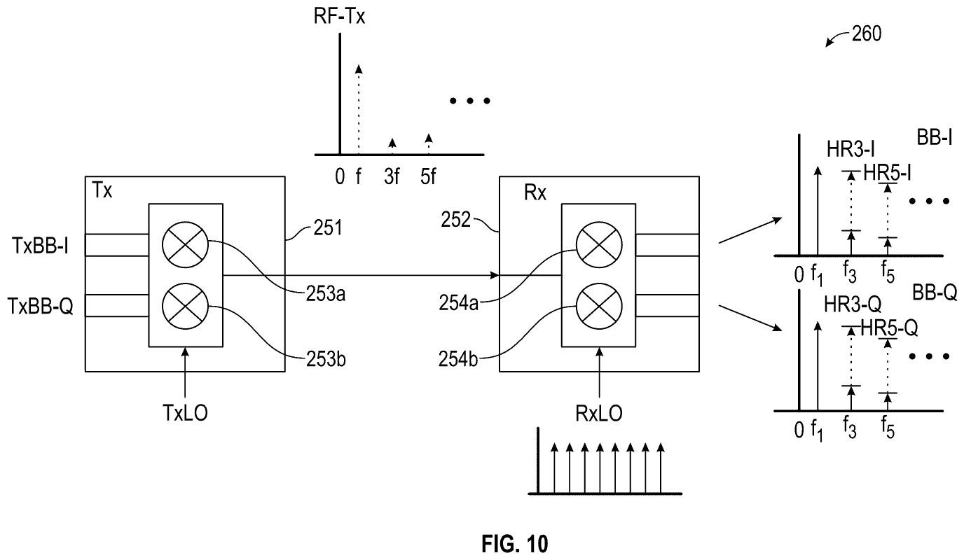

FIG. 10 is a schematic diagram of one embodiment of a transmit mixer calibration system 260. The transmit mixer calibration system 260 includes a transmit mixer 251 that includes an I-channel 253a and a Q-channel 253b and a receive mixer 252 that includes an I-channel 254a and a Q-channel 254b. The output of the I-channel 254a and the output of the Q-channel 254b can be digitized (for example, using ADCs 21a/21b of FIG. 1) and processed by digital processing to detect the harmonic content.

As shown in FIG. 10, the transmit mixer calibration system 260 is implemented such that a frequency upshifted transmit signal from the transmit mixer 251 is downshifted by the receive mixer 252. Additionally, the transmit mixer 251 receives a transmit local oscillator signal TxLO, while the receive mixer 252 receives a receive local oscillator signal RxLO that is a harmonic rich LO signal. For example, the receive local oscillator signal RxLO can have a comb-like spectrum in the frequency domain. By implementing the receive local oscillator signal RxLO in this manner, transmit harmonics can be efficiently captured to thereby allow the transmit mixer 251 to be calibrated.

With continuing reference to FIG. 10, the transmit local oscillator signal TxLO and the receive local oscillator signal RxLO can be skewed such that the fundamental and spurious components are separated in frequency at receive baseband (RxBB). Additionally, using the received fundamental tone as a reference, the rejection of each harmonic for both I and Q channels can be calculated. Further, the depicted embodiment allows for simultaneous visibility of multiple harmonic rejection ratios.

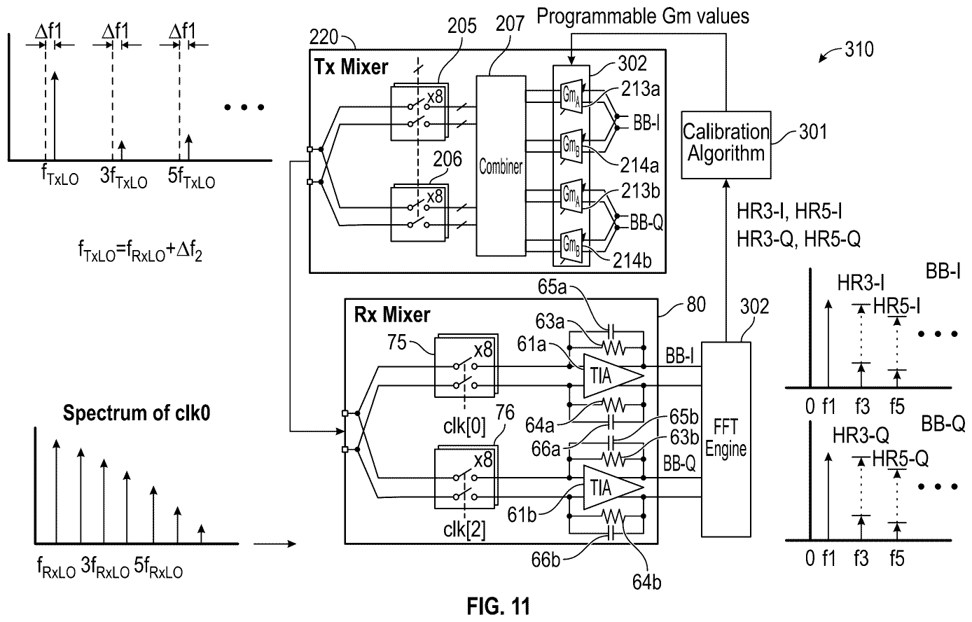

FIG. 11 is a schematic diagram of another embodiment of a transmit mixer calibration system 310. The transmit mixer calibration system 310 includes a transmit mixer 220, a receive mixer 80, and digital processing circuitry implementing an FFT engine 302 and a calibration algorithm 301.

The transmit mixer calibration system 160 of FIG. 11 is similar to the transmit mixer calibration system 260 of FIG. 10, except that in FIG. 11 a specific implementation of a transmit mixer (corresponding to the transmit mixer 220 of FIG. 9A) is undergoing calibration of transconductance values Gm_{A} and Gm_{B} using an FFT analysis on an output of a receive mixer (corresponding to the receive mixer 80 of FIG. 5A). In particular, the FFT engine 302 calculates HR3-I, HR3-Q, HR5-I, and HR5-Q from the output of the receive mixer 80.

In the illustrated embodiment, the transmit local oscillator has a frequency offset Δf1, and f_{TxLO}=f_{RxLO}+Δf2. Additionally, f1=Δf2+Δf1, f3=3Δf2+Δf1, and f5=5Δf2+Δf1.

In certain implementations, the calibration algorithm 301 performs additional calibrations, such as an adjustment of one or more components for QEC.

### CONCLUSION

The foregoing description may refer to elements or features as being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the figures depict example arrangements of elements and components, additional intervening elements, devices, features, or components may be present in an actual embodiment (assuming that the functionality of the depicted circuits is not adversely affected).

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while the disclosed embodiments are presented in a given arrangement, alternative embodiments may perform similar functionalities with different components and/or circuit topologies, and some elements may be deleted, moved, added, subdivided, combined, and/or modified. Each of these elements may be implemented in a variety of different ways. Any suitable combination of the elements and acts of the various embodiments described above can be combined to provide further embodiments. Accordingly, the scope of the present invention is defined only by reference to the appended claims.

Although the claims presented here are in single dependency format for filing at the USPTO, it is to be understood that any claim may depend on any preceding claim of the same type except when that is clearly not technically feasible.

What is claimed is:

1. A mixer comprising:
a plurality of in-phase (I) signal paths controlled by a plurality of clock signal phases of a local oscillator;
a plurality of quadrature-phase (Q) signals paths controlled by the plurality of clock signal phases, wherein each clock signal phase of the plurality of clock signal phases selects a corresponding I signal path of the plurality of I signal paths and a corresponding Q signal path of the plurality of Q signal paths,
wherein a total absolute current from the plurality of I signal paths and the plurality of Q signal paths is substantially constant for each of the clock signal phases.

2. The mixer of claim 1, wherein the plurality of I signal paths and the plurality of Q signal paths time share two or more components across the plurality of clock signal phases, wherein the two or more components include a first component of a first component value and a second component of a second component value.

3. The mixer of claim 2, wherein the plurality of I signal paths and the plurality of Q signal paths are each operable in a selected state chosen from a plurality of states, wherein the plurality of states include a first state in which the first component value is selected and a channel polarity is not inverted, a second state in which the second component value is selected and the channel polarity is not inverted, a third state in which the first component value is selected and the channel polarity is inverted, and a fourth state in which the second component value is selected and the channel polarity is inverted.

4. The mixer of claim 2, wherein for each of the plurality of clock signal phases, the corresponding I signal path operates with one of the first component value or the second component value and the corresponding Q signal path operates with the other of the first component value or the second component value.

5. The mixer of claim 2, wherein the first component value and the second component value correspond to resistances or transconductances.

6. The mixer of claim 2, further comprising a calibration system configured to adjust at least one of the first component value or the second component value to calibrate the mixer.

7. The mixer of claim 6, wherein the calibration system includes a fast Fourier transform engine configured to observe a harmonic output of the mixer, and a calibration engine configured to calibrate at least one of the first component value or the second component value based on the harmonic output.

8. The mixer of claim 1, wherein the plurality of I signal paths are weighted according to a cosine function with a phase offset, and the plurality of Q signal paths are weighted according to a sine function with the phase offset.

9. The mixer of claim 8, wherein the plurality of I signal paths and the plurality of Q signal paths each include n signal paths and the phase offset is about π/n.

10. The mixer of claim 9, wherein the plurality of I signal paths and the plurality of Q signal paths each include 8 signal paths and the phase offset is about π/8.

11. The mixer of claim 8, wherein each of the plurality of I signal paths includes at least one component weighted according to the cosine function, and wherein each of the plurality of Q signal paths includes at least one component weighted according to the sine function.

12. The mixer of claim 1, implemented as a receive mixer.

13. The mixer of claim 12, further comprising an I-channel transimpedance amplifier (TIA) shared by the plurality of I signal paths and a Q-channel TIA shared by the plurality of Q signal paths.

14. The mixer of claim 1, implemented as a transmit mixer.

15. A method of mixing with harmonic rejection, the method comprising:
controlling a plurality of in-phase (I) signal paths of a mixer using a plurality of clock signal phases of a local oscillator;
controlling a plurality of quadrature-phase (Q) signals paths of the mixer using the plurality of clock signal phases, wherein each clock signal phase of the plurality of clock signal phases selects a corresponding I signal path of the plurality of I signal paths and a corresponding Q signal path of the plurality of Q signal paths; and
maintaining a total absolute current from the plurality of I signal paths and the plurality of Q signal paths substantially constant for each of the clock signal phases.

16. The method of claim 15, further comprising time sharing two or more components for the plurality of I signal paths and the plurality of Q signal paths across the plurality of clock signal phases, wherein the two or more components include a first component of a first component value and a second component of a second component value.

17. The method of claim 15, wherein the plurality of I signal paths are weighted according to a cosine function with a phase offset, and the plurality of Q signal paths are weighted according to a sine function with the phase offset.

18. A radio frequency communication system comprising:
a local oscillator configured to generate a plurality of clock signal phases; and
a mixer comprising:
a plurality of in-phase (I) signal paths controlled by the plurality of clock signal phases;
a plurality of quadrature-phase (Q) signals paths controlled by the plurality of clock signal phases, wherein each clock signal phase of the plurality of clock signal phases selects a corresponding I signal path of the plurality of I signal paths and a corresponding Q signal path of the plurality of Q signal paths,
wherein a total absolute current from the plurality of I signal paths and the plurality of Q signal paths is substantially constant for each of the clock signal phases.

19. The radio frequency communication system of claim 18, wherein the plurality of I signal paths and the plurality of Q signal paths time share two or more components across the plurality of clock signal phases, wherein the two or more components include a first component of a first component value and a second component of a second component value.

20. The radio frequency communication system of claim 18, wherein the plurality of I signal paths are weighted according to a cosine function with a phase offset, and the plurality of Q signal paths are weighted according to a sine function with the phase offset.
